(19) United States
(12) Patent Application Publication
(10) Pub. No.: US 2020/0363928 A1
(43) Pub. Date: Nov. 19, 2020

(54) FOLDABLE SCREEN AND METHOD OF CONTROLLING SAME

(71) Applicant: WUHAN CHINA STAR OPTOELECTRONICS SEMICONDUCTOR DISPLAY TECHNOLOGY CO., LTD., Wuhan, Hubei (CN)

(72) Inventors: Dan LIN, Wuhan, Hubei (CN); Qibing DAI, Wuhan, Hubei (CN); Minlun LIU, Wuhan, Hubei (CN)

(21) Appl. No.: 16/497,881

(22) PCT Filed: Jul. 2, 2019
(86) PCT No.: PCT/CN2019/094435

§ 371 Date: Sep. 26, 2019

(30) Foreign Application Priority Data
May 14, 2019 (CN) 201910399166.8

(51) Int. Cl. G06F 3/041; G06F 3/044; G06F 1/16

(52) U.S. Cl. CPC G06F 3/04186; G06F 3/0445; G06F 2203/04102; G06F 1/1652; G06F 3/0448

(57) ABSTRACT

A foldable screen and a method of controlling the same are provided. The foldable screen includes a first zone, a second zone, and a first foldable zone between the first zone and the second zone. A first touch electrode is disposed in the first zone and a second touch electrode is disposed in the second zone. The first foldable zone is provided with a first electrode electrically connected to the first touch electrode, a second electrode electrically connected to the second touch electrode, and a barrier electrode between the first electrode and the second electrode.

### FIELD OF INVENTION

The present invention relates to the field of display, and more particularly to a foldable screen and a method of controlling the same.

### BACKGROUND

With development of technology, the appearance of mobile electronic devices has undergone tremendous changes. Among them, flexible screens have attracted much attention due to their unique characteristics and huge potential. Compared with traditional screens, flexible screens are flexible and bendable, which can reduce the degree of accidental damage to the equipment, and are much more durable than other screens. Moreover, flexible screens provide users with new ways of interaction based on the bendable characteristic, which can meet more of users' needs for electronic devices.

At present, the scheme of using the flexible screen in the mobile electronic device is mainly to fold the device, which may be called a foldable screen. Since the foldable screen covers the outside of the device, the palm or the finger may touch the screen portion during the folding of the device or the use of the foldable device, thereby causing a false touch and troubles to the user. Moreover, for devices using a foldable screen, the foldable screen is operated in a high frequency, and frequent false touches seriously affect the user experience.

### SUMMARY

The present application a foldable screen and a method of controlling the same to solve the technical problems of false touches during the touch operation of the user.

To achieve the above object, the present invention provides the following technical solutions.

The present application provides a foldable screen comprising a first zone, a second zone, and a first foldable zone between the first zone and the second zone.

A first touch electrode is disposed in the first zone.

A second touch electrode is disposed in the second zone.

The first foldable zone is provided with:

a first electrode electrically connected to the first touch electrode;

a second electrode electrically connected to the second touch electrode; and

a barrier electrode between the first electrode and the second electrode.

In the foldable screen of the present application, the barrier electrode extends from a first side of the foldable screen to a second side opposite the first side.

The barrier electrode is stripe-shaped or chain-shaped.

In the foldable screen of the present application, the barrier electrode has a width of less than 1 cm.

In the foldable screen of the present application, the foldable screen further comprising a detecting module, a driving chip, and a touch chip.

The detecting module is configured to identify a bending state of the foldable screen and output a bending signal.

The driving chip is configured to cause at least one of the first zone, the second zone, and the first foldable zone to be in a display state according to the bending signal.

The touch chip is configured to cause at least one of the first zone, the second zone, and the first foldable zone to be in an effective touch zone according to the bending signal.

In the foldable screen of the present application,

the detecting module comprises a detecting unit and an identification unit.

The detecting unit is configured to detect a folding angle of the foldable screen.

The identification unit is configured to identify a zone corresponding to the foldable screen and the user.

In the foldable screen of the present application,

the foldable screen is in an unfolded state when the folding angle is 0 degrees, and the driving chip causes the first zone, the second zone, and the first foldable zone to be in the display state.

The foldable screen is in a folded state when the folding angle is 180 degrees.

The driving chip causes the first zone, the second zone, and the first foldable zone to be in a non-display state when the foldable screen is in an inward folded state;

the driving chip causes the first zone facing the user to be in a display state, and the second zone and the first foldable zone facing away from the user are in a non-display state when the foldable screen is in an outward folded state; or

the driving chip causes the second zone facing the user to be in a display state, and the first zone and the first foldable zone facing away from the user are in a non-display state when the foldable screen is in an outward folded state.

In the foldable screen of the present application,

the touch chip causes the first zone and the first foldable zone facing away from the user to be in invalid touch zones, and the second zone facing the user to be in an effective touch zone when the foldable screen is in an outward folded state; or

the touch chip causes the second zone and the first foldable zone facing away from the user to be invalid touch zones, and the first zone facing the user to be an effective touch zone when the foldable screen is in an outward folded state.

In the foldable screen of the present application,

the touch chip causes the first electrode in the first zone and the first electrode and the second electrode in the first foldable zone facing away from the user to be in an inactive state, and the second electrode in the second zone facing the user to be in an active state when the foldable screen is in an outward folded state; or

the touch chip causes the second electrode in the second zone and the first electrode and the second electrode of the first foldable zone facing away from the user to be in an inactive state, and the first electrode in the first zone opposite the user to be in an active state when the foldable screen is in an outward folded state.

In the foldable screen of the present application, the foldable screen further comprises a third zone and a second foldable zone; and

the second foldable zone is between the third zone and the second zone.

In the foldable screen of the present application, a sum of surface areas of the first zone and the third zone is equal to a surface area of the second zone; or

the first zone, the second zone, and the third zone have equal surface areas.

The present application further provides a method of controlling a foldable screen, the foldable screen comprising a first zone, a second zone, and a first foldable zone between the first zone and the second zone, wherein the method of controlling the foldable screen comprising:

detecting a bending state of the foldable screen and outputting a bending signal; and

causing at least one of the first zone, the second zone, and the first foldable zone to be in a display state according to the bending signal.

In the control method of the present application, detecting the bending state of the foldable screen and outputting the bending signal comprises the following steps:

detecting a folding angle of the foldable screen; and

determining a zone of the foldable screen facing the user according to the folding angle of the foldable screen and outputting the corresponding bending signal.

In the control method of the present application,

the foldable screen further comprises a driving chip;

the foldable screen is in an unfolded state when the folding angle is 0 degrees, and the driving chip causes the first zone, the second zone, and the first foldable zone to be in a display state; and

the foldable screen is in a folded state when the folding angle is 180 degrees;

the driving chip causes the first zone, the second zone, and the first foldable zone to be in a non-display state when the foldable screen is in an inward folded state;

the driving chip causes the first zone facing the user to be in a display state, and the second zone and the first foldable zone facing away from the user are in a non-display state when the foldable screen is in an outward folded state; or

the driving chip causes the second zone facing the user to be in a display state, and the first zone and the first foldable zone facing away from the user are in a non-display state when the foldable screen is in an outward folded state.

In the control method of the present application,

the foldable screen further comprises a touch chip; and

the touch chip causes the first zone and the first foldable zone facing away from the user to be in invalid touch zones, and the second zone facing the user to be in an effective touch zone when the foldable screen is in an outward folded state; or

the touch chip causes the second zone and the first foldable zone facing away from the user to be invalid touch zones, and the first zone facing the user to be an effective touch zone when the foldable screen is in an outward folded state.

In the control method of the present application,

a first touch electrode is disposed in the first zone;

a second touch electrode is disposed in the second zone; and

the first foldable zone is provided with:

a first electrode electrically connected to the first touch electrode;

a second electrode electrically connected to the second touch electrode; and

a barrier electrode between the first electrode and the second electrode.

In the control method of the present application, the barrier electrode extends from a first side of the foldable screen to a second side opposite the first side.

In the control method of the present application, the barrier electrode has a width of less than 1 cm.

In the control method of the present application,

the touch chip causes the first electrode in the first zone and the first electrode and the second electrode in the first foldable zone facing away from the user to be in an inactive state, and the second electrode in the second zone facing the user to be in an active state when the foldable screen is in an outward folded state; or

the touch chip causes the second electrode in the second zone and the first electrode and the second electrode of the first foldable zone facing away from the user to be in an inactive state, and the first electrode in the first zone facing the user to be in an active state when the foldable screen is in an outward folded state.

In the control method of the present application,

the foldable screen further comprises a third zone and a second foldable zone; and

the second foldable zone is between the third zone and the second zone.

In the control method of the present application,

a sum of surface areas of the first zone and the third zone is equal to a surface area of the second zone; or

the first zone, the second zone, and the third zone have equal surface areas.

ADVANTAGEOUS EFFECTS: The present application provides a foldable screen and a method of controlling the same. The foldable screen comprises a first zone, a second zone, and a first foldable zone between the first zone and the second zone. The foldable screen further comprises a detecting module, a driving chip, and a touch chip. The detecting module is configured to identify a bending state of the foldable screen and output a bending signal. The driving chip is configured to cause at least one of the first zone, the second zone, and the first foldable zone to be in a display state according to the bending signal. The present application divides the foldable screen into a plurality of zones, and performs partition control on the foldable screen, thereby avoiding a user's false touch when performing a touch operation.

### BRIEF DESCRIPTION OF DRAWINGS

To detailly explain the technical schemes of the embodiments or existing techniques, drawings that are used to illustrate the embodiments or existing techniques are provided. Apparently, the illustrated embodiments are just a part of those of the present disclosure. It is easy for any person having ordinary skill in the art to obtain other drawings without labor for inventiveness.

FIG. 1 is an unfolded structural view of a foldable screen of the present application;

FIG. 2 is a first folded structural diagram of a foldable screen of the present application;

FIG. 3 is a second folded structural diagram of a foldable screen of the present application;

FIG. 4 is a third foldable structural diagram of the foldable screen of the present application; and

FIG. 5 is a flowchart of a method of controlling a foldable screen of the present application.

### DETAILED DESCRIPTION

The following description of the various embodiments is provided to illustrate the specific embodiments. Directional terms mentioned in this application, such as “upper”, “lower”, “front”, “rear”, “left”, “right”, “inside”, “outside”, “side”, etc., are only illustrations of the drawings. Therefore, the directional terminology is used for the purpose of illustration and understanding, but not intended to be limiting. In the figures, elements of similar structures are assigned with the same reference numerals.

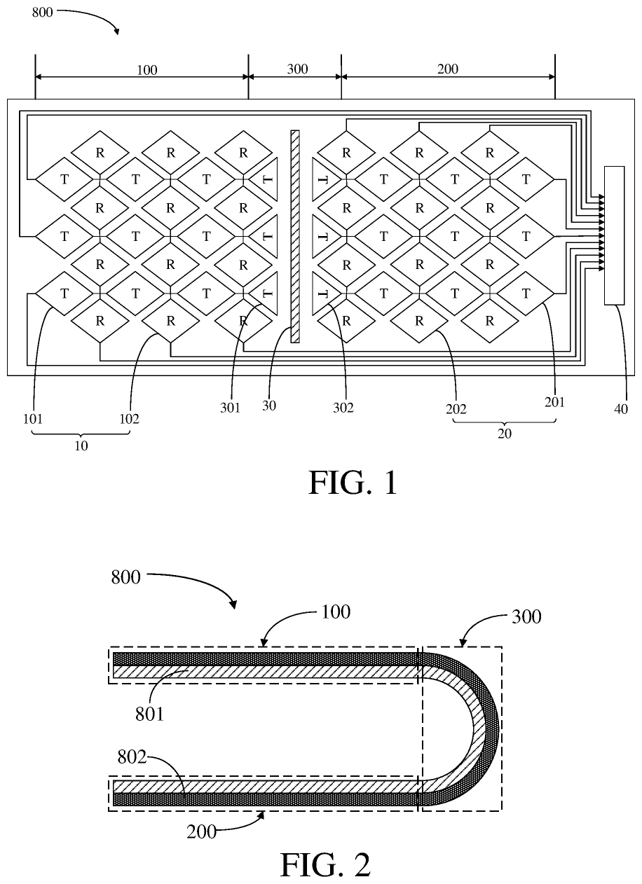

Referring to FIG. 1, FIG. 1 is an unfolded structural view of a foldable screen of the present application.

The foldable screen 800 comprises a substrate 801 and a display panel 802 disposed over the substrate 801. The display panel 802 comprises a first zone 100, a second zone 200, and a first foldable zone 300 between the first zone 100 and the second zone 200.

A first touch electrode 10 is disposed in the first zone 100 along a first direction or a second direction, and a second touch electrode 20 is disposed in the second zone 200 along the first direction and the second direction.

The first touch electrode 10 comprises a plurality of first driving electrodes 101 and first sensing electrodes 102. The second touch electrode 20 comprises a plurality of second driving electrodes 201 and a second sensing electrodes 202.

In this embodiment, the first driving electrodes 101 and the first sensing electrodes 102 can be disposed in the same layer or in different layers.

In this embodiment, the second driving electrodes 201 and the second sensing electrodes 202 can be disposed in the same layer or in different layers.

In this embodiment, the first driving electrodes 101 and the second driving electrodes 201 are arranged along the first direction, and the first sensing electrodes 102 and the second sensing electrodes 202 are arranged along the second direction.

In this embodiment, the first direction is a horizontal direction, and the second direction is a vertical direction.

The first foldable zone 300 is provided with a first electrode 301 electrically connected to the first touch electrode 10, and a second electrode 302 electrically connected to the second touch electrode 20.

In this embodiment, the first electrode 301 is electrically connected to the first driving electrode 101, and the second electrode 302 is electrically connected to the second driving electrode 201.

A barrier electrode 30 between the first electrode 301 and the second electrode 302 is further disposed in the first foldable zone 300. The barrier electrode 30 extends from a first side of the foldable screen 800 to a second side opposite the first side.

In this embodiment, the barrier electrode 30 extends from a first side AB to a second side CD along the second direction.

In this embodiment, the barrier electrode 30 has a width of less than 1 cm.

In this embodiment, the barrier electrode 30 can be stripe-shaped, hollow chain-shaped, or the like.

In this embodiment, through holes are disposed in the barrier electrode 30 to enhance the flexibility of the barrier electrode 30

Referring to FIG. 1, the driving electrodes are disposed laterally and the sensing electrodes are disposed vertically. The existence of the first foldable zone of the present application allows the channel of the original driving electrode to become one-half of the prior art, which not only reduces the impedance of the channel of driving electrode, but also reduces the load of the channel, thereby ensuring the integrity of the touch control signal.

The foldable screen 800 further comprises a detecting module and a driving chip.

The detecting module is configured to identify a bending state of the foldable screen 800 and output a bending signal. In this embodiment, the detecting module comprises a detecting unit and an identification unit. The detecting unit is configured to detect a folding angle of the foldable screen 800. The identification unit is configured to identify a zone of the foldable screen 800 corresponding to the user.

For example, when the foldable screen 800 is folded, the detecting unit detects a folding angle of the foldable screen 800 and determines whether the foldable screen 800 is folded and a degree of folding thereof. When the foldable screen 800 completes the folding, it is determined that the identification unit identifies the zone of the foldable screen 800 corresponding to the user, and outputs a corresponding bending signal.

In one embodiment, the detecting module can only comprise the identification unit. The zone of the foldable screen 800 corresponding to the user is determined according to the identification unit and outputs a corresponding bending signal to the driving chip.

The driving chip causes at least one of the first zone 100, the second zone 200, and the first foldable zone 300 to be in a display state according to the bending signal.

The foldable screen 800 further comprises a touch chip 40. The touch chip 40 is configured to cause the touch electrodes in at least one of the first zone 100, the second zone 200, and the first foldable zone 300 to be in an active state according to the bending signal.

Referring to FIG. 1, when the foldable screen 800 is in an unfolded state:

The detecting unit detects that the folding angle of the foldable screen 800 is 0 degree. The identification unit identifies that the user is facing the first zone 100, the second zone 200, and the first foldable zone 300 in the foldable screen 800, and outputs a first bending signal.

The driving chip receives the first bending signal and causes the first zone 100, the second zone 200, and the first foldable zone 300 facing the user to be in a display state.

The touch chip 40 receives the first bending signal and causes the first zone 100, the second zone 200, and the first foldable zone 300 facing the user to be effective touch zones.

When the foldable screen 800 is in a folded state:

The detecting unit detects that the folding angle of the foldable screen 800 is 180 degrees. The foldable state of the foldable screen 800 comprises an inward folded state and an outward folded state.

Referring to FIG. 2, FIG. 2 is a first folded structural diagram of the foldable screen 800 of the present application.

When the foldable screen 800 is in an inward folded state:

The identification unit fails to identify that the user is facing one of the first zone 100, the second zone 200, and the first foldable zone 300 in the foldable screen 800, and outputs a second bending signal.

The driving chip receives the second bending signal and causes the first zone 100, the second zone 200, and the first foldable zone 300 that are not facing the user to be in a non-display state.

The touch chip 40 receives the second bending signal and causes the first zone 100, the second zone 200, and the first foldable zone 300 that are not facing the user to be invalid touch zones.

FIG. 3 is a second folded structural diagram of the foldable screen 800 of the present application.

When the foldable screen 800 is in an outward folded state:

The identification unit identifies that the user is facing one of the first zone 100, the second zone 200, and the first foldable zone 300 in the foldable screen 800, and outputs a third bending signal.

The driving chip receives the third bending signal and causes the first zone 100 facing the user to be in a display state, and the second zone 200 and the first foldable zone 300 facing away from the user to be in a non-display state.

The touch chip 40 receives the third bending signal and causes the first zone 100 facing the user to be an effective touch zone, and the second zone 200 and the first foldable zone 300 facing away from the user to be invalid touch zones.

Or

The driving chip receives the third bending signal and causes the second zone 200 facing the user to be in a display state, and the first zone 100 and the first foldable zone 300 facing away from the user to be in a non-display state.

The touch chip 40 receives the third bending signal and causes the second zone 200 facing away from the user to be an effective touch zone, and the first zone 100 and the first foldable zone 300 not facing away from the user to be invalid touch zones.

Since the first electrode 301 and the second electrode 302 are disposed in the folded region 300, the first electrode 301 is electrically connected to the first touch electrode 10, and the second electrode 302 is electrically connected to the second touch electrode 20. Therefore, when the foldable screen 800 is in the outward folded state, the touch chip 40 causes the state of the touch electrodes in the corresponding first zone 100 or the second zone 200 to be in an inactive state, and also causes the first electrode 301 and the second electrodes to be in an inactive state.

In this embodiment, when the foldable screen 800 is in an outward folded state:

The touch chip 40 causes the first electrode in the first zone 100 and the first electrode 301 and the second electrode 302 in the first foldable zone 300 facing away from the user to be in an inactive state, and the second electrode in the second zone 200 facing the user is in an active state.

Or

The touch chip 40 causes the second electrode in the second zone 200 facing away from the user and the first electrode 301 and the second electrode 302 in the first foldable zone 300 to be in an inactive state, and causes the first electrode in the first zone 100 facing the user to be in an active state.

When the foldable screen 800 is in an outward folded state, due to the presence of the barrier electrode 30, the first touch electrode 10 in the first zone 100 and the second touch electrode 20 in the second zone 200 do not interfere with each other, and the touch electrodes in the first zone 100 and the second zone 200 can be driven by itself, thereby preventing the occurrence of user's false touch.

When the foldable screen 800 is in the unfolded state, due to the presence of the barrier electrode 30, the touch electrodes in the first zone 100 and the second zone 200 are in a discontinuous state. Therefore, when a touch operation is extended from the first zone 100 to the second zone 200, a specific algorithm of the touch chip 40 causes the touch operation to extend from the first electrode 301 to the second electrode 302, thereby ensuring the continuity of the touch operation over the foldable screen 800.

In this embodiment, when the first zone 100 is facing the user, the first zone 100 is in a display state, and the second zone 200 is in a non-display state.

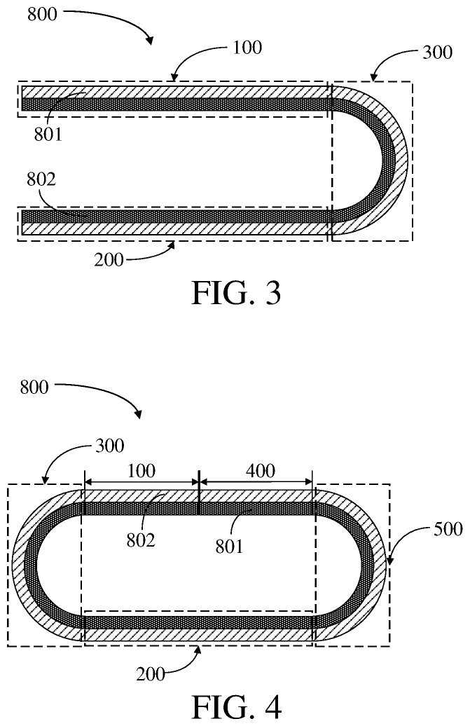

Referring to FIG. 4, FIG. 4 is a third foldable structural diagram of the foldable screen 800 of the present application.

The foldable screen 800 further comprises a third zone 400 and a second foldable zone 500.

The second foldable zone 500 is between the third zone 400 and the second zone 200.

In this embodiment, a sum of surface areas of the first zone 100 and the third zone 400 is equal to a surface area of the second zone 200.

In this embodiment, the surface areas of the first zone 100 and the third zone 400 are equal. The first zone 100 and the third zone 400 are symmetrically disposed along a center line of the second zone 200.

When the foldable screen 800 is in an outward foldable state, the first zone 100 and the third zone 400 are in a non-display state, and the second zone 200 is in a display state.

In the foldable screen 800 of the present application, the foldable screen 800 is not limited to comprising the first zone 100, the second zone 200, and the third zone 400, and may comprises three or more zones.

The present invention divides the foldable screen 800 into a plurality of zones, and performs partition control on the foldable screen 800, thereby preventing a user's false touch when performing a touch operation.

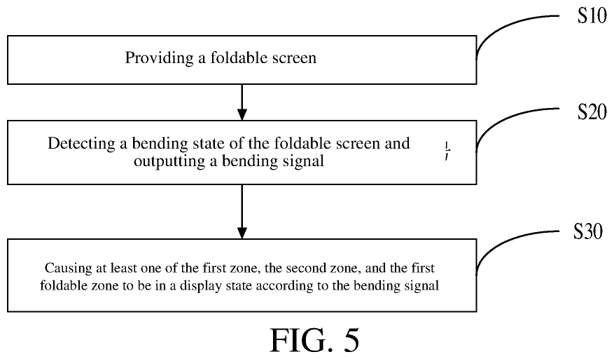

Referring to FIG. 5, FIG. 5 is a flowchart of a method of controlling the foldable screen 800 of the present application.

In step S10, providing a foldable screen 800;

Referring to FIG. 1, the foldable screen 800 comprises a substrate 801 and a display panel 802 disposed over the substrate 801. The display panel 802 comprises a first zone 100, a second zone 200, and a first foldable zone 300 between the first zone 100 and the second zone 200.

A first touch electrode 10 is disposed in the first zone 100 along a first direction or a second direction, and a second touch electrode 20 is disposed in the second zone 200 along the first direction and the second direction.

The first touch electrode 10 comprises a plurality of first driving electrodes 101 and first sensing electrodes 102. The second touch electrode 20 comprises a plurality of second driving electrodes 201 and second sensing electrodes 202.

In this embodiment, the first driving electrodes 101 and the second driving electrodes 201 are arranged along the first direction, and the first sensing electrodes 102 and the second sensing electrodes 202 are arranged along the second direction.

In this embodiment, the first direction is a horizontal direction, and the second direction is a vertical direction.

The first foldable zone 300 is provided with a first electrode 301 electrically connected to the first touch electrode 10, and a second electrode 302 electrically connected to the second touch electrode 20.

In this embodiment, the first electrode 301 is electrically connected to the first driving electrode 101, and the second electrode 302 is electrically connected to the second driving electrode 201.

A barrier electrode 30 between the first electrode 301 and the second electrode 302 is further disposed in the first foldable zone 300. The barrier electrode 30 extends from a first side of the foldable screen 800 to a second side opposite the first side.

In this embodiment, the barrier electrode 30 extends from a first side AB to a second side CD along the second direction.

In this embodiment, the barrier electrode 30 has a width of less than 1 cm.

In this embodiment, the barrier electrode 30 can be stripe-shaped, hollow chain-shaped, or the like.

In this embodiment, through holes can be disposed in the barrier electrode 30 to enhance the flexibility of the barrier electrode 30

Referring to FIG. 1, the driving electrodes are disposed laterally and the sensing electrodes are disposed vertically. The existence of the first foldable zone of the present application allows the channel of the original driving electrode become one-half of the prior art, which not only reduces the impedance of the channel of driving electrode, but also reduces the load of the channel, thereby ensuring the integrity of the touch control signal.

In step 20, detecting a bending state of the foldable screen and outputting a bending signal:

The foldable screen 800 further comprises a detecting module. The foldable screen 800 detects a bending state of the foldable screen 800 through the detecting module and outputs the bending signal.

The detecting module comprises a detecting unit and an identification unit.

This step comprises:

In step S201, detecting a folding angle of the foldable screen 800.

In step S202, determining a zone of the foldable screen 800 facing the user according to the folding angle of the foldable screen and outputting the corresponding bending signal.

In this step, when the foldable screen 800 is folded, the detecting unit detects a folding angle of the foldable screen 800 and determines whether the foldable screen 800 is folded and a degree of folding thereof. When the foldable screen 800 completes the folding, it is determined that the identification unit identifies the zone of the foldable screen 800 corresponding to the user, and outputs a corresponding bending signal.

In one embodiment, the detecting module can only comprise the identification unit. The zone of the foldable screen 800 corresponding to the user is determined according to the identification unit and outputs a corresponding bending signal to the driving chip.

In step S30, causing at least one of the first zone, the second zone, and the first foldable zone to be in a display state according to the bending signal.

The foldable screen 800 comprises a driving chip.

In this step, the foldable screen 800 causes at least one of the first zone 100, the second zone 200, and the first foldable zone 300 to be in a display state through the driving chip.

The foldable screen 800 further comprises a touch chip 40.

In this step, the foldable screen 800 causes at least one of the first zone 100, the second zone 200, and the first foldable zone 300 to be in an active state through the touch chip 40.

Referring to FIG. 1, when the foldable screen 800 is in an unfolded state:

The detecting unit detects that the folding angle of the foldable screen 800 is 0 degree. The identification unit identifies that the user is facing the first zone 100, the second zone 200, and the first foldable zone 300 in the foldable screen 800, and outputs a first bending signal.

The foldable screen 800 receives the first bending signal and causes the first zone 100, the second zone 200, and the first foldable zone 300 facing the user to be in a display state through the driving chip.

The foldable screen 800 receives the first bending signal and causes the first zone 100, the second zone 200, and the first foldable zone 300 facing the user to be effective touch zones through the touch chip 40.

When the foldable screen 800 is in a folded state:

The detecting unit detects that the folding angle of the foldable screen 800 is 180 degrees. The foldable state of the foldable screen 800 comprises an inward folded state and an outward folded state.

Referring to FIG. 2, FIG. 2 is a first folded structural diagram of the foldable screen 800 of the present application.

When the foldable screen 800 is in an inward folded state:

The foldable screen 800 fails to identify that the user is facing one of the first zone 100, the second zone 200, and the first foldable zone 300 in the foldable screen 800 through the identification unit, and outputs a second bending signal.

The foldable screen 800 receives the second bending signal through the driving chip and causes the first zone 100, the second zone 200, and the first foldable zone 300 that are not facing the user to be in a non-display state.

The foldable screen 800 receives the second bending signal through the touch chip 40 and causes the first zone 100, the second zone 200, and the first foldable zone 300 that are not facing the user to be invalid touch zones.

Referring to FIG. 3, FIG. 3 is a second folded structural diagram of the foldable screen 800 of the present application.

When the foldable screen 800 is in an outward folded state:

The foldable screen 800 identifies that the user is facing one of the first zone 100, the second zone 200, and the first foldable zone 300 in the foldable screen 800 through the identification unit, and outputs a third bending signal.

The foldable screen 800 receives the third bending signal through the driving chip and causes the first zone 100 facing the user to be in a display state, and the second zone 200 and the first foldable zone 300 facing away from the user to be in a non-display state.

The touch chip 40 receives the third bending signal and causes the first zone 100 facing the user to be an effective touch zone, and the second zone 200 and the first foldable zone 300 facing away from the user to be invalid touch zones.

Or

The foldable screen 800 receives the third bending signal through the driving chip and causes the second zone 200 facing the user to be in a display state, and the first zone 100 and the first foldable zone 300 facing away from the user to be in a non-display state.

The foldable screen 800 receives the third bending signal through the touch chip 40 and causes the second zone 200 facing away from the user to be an effective touch zone, and the first zone 100 and the first foldable zone 300 not facing away from the user to be invalid touch zones.

Since the first electrode 301 and the second electrode 302 are disposed in the foldable zone, the first electrode 301 is electrically connected to the first touch electrode 10, and the second electrode 302 is electrically connected to the second touch electrode 20. Therefore, when the foldable screen 800 is in the outward folded state, the touch chip 40 causes the state of the touch electrodes in the corresponding first zone 100 or the second zone 200 to be in an inactive state, and also causes the first electrode 301 and the second electrodes to be in an inactive state.

In this embodiment, when the foldable screen 800 is in an outward folded state:

The foldable screen 800 causes the first electrode in the first zone 100 and the first electrode 301 and the second electrode 302 in the first foldable zone 300 facing away from the user to be in an inactive state, and the second electrode in the second zone 200 facing the user to be in an active state through the touch chip 40.

Or

The foldable screen 800 causes the second electrode in the second zone 200 facing away from the user and the first electrode 301 and the second electrode 302 in the first foldable zone 300 to be in an inactive state, and causes the first electrode in the first zone 100 facing the user to be in an active state through the touch chip 40.

When the foldable screen 800 is in an outward folded state, due to the presence of the barrier electrode 30, the first touch electrode 10 in the first zone 100 and the second touch electrode 20 in the second zone 200 do not interfere with each other, and the touch electrodes in the first zone 100 and the second zone 200 can be driven by itself, thereby preventing the occurrence of user's false touch.

When the foldable screen 800 is in the unfolded state, due to the presence of the barrier electrode 30, the touch electrodes in the first zone 100 and the second zone 200 are in a discontinuous state. Therefore, when a touch operation is extended from the first zone 100 to the second zone 200, a specific algorithm of the touch chip 40 causes the touch operation to extend from the first electrode 301 to the second electrode 302, thereby ensuring the continuity of the touch operation over the foldable screen 800.

The present application provides a foldable screen and a method of controlling the same. The foldable screen comprises a first zone, a second zone, and a first foldable zone between the first zone and the second zone. A first touch electrode is disposed in the first zone and a second touch electrode is disposed in the second zone. The first foldable zone is provided with a first electrode electrically connected to the first touch electrode, a second electrode electrically connected to the second touch electrode, and a barrier electrode between the first electrode and the second electrode. The present application divides the foldable screen into a plurality of zones, and performs partition control on the foldable screen, thereby preventing a user's false touch when performing a touch operation.

While the present disclosure has been described with the aforementioned preferred embodiments, it is preferable that the above embodiments should not be construed as limiting of the present disclosure. Anyone having ordinary skill in the art can make a variety of modifications and variations without departing from the spirit and scope of the present disclosure as defined by the following claims.

What is claimed is:

1. A foldable screen, comprising a first zone, a second zone, and a first foldable zone between the first zone and the second zone;
wherein a first touch electrode is disposed in the first zone
a second touch electrode is disposed in the second zone; and
the first foldable zone is provided with:
a first electrode electrically connected to the first touch electrode;
a second electrode electrically connected to the second touch electrode; and
a barrier electrode between the first electrode and the second electrode.

2. The foldable screen of claim 1, wherein the barrier electrode extends from a first side of the foldable screen to a second side opposite the first side, and the barrier electrode is stripe-shaped or chain-shaped.

3. The foldable screen of claim 1, wherein the barrier electrode has a width of less than 1 cm.

4. The foldable screen of claim 1, further comprising a detecting module, a driving chip, and a touch chip;
wherein the detecting module is configured to identify a bending state of the foldable screen and output a bending signal;
the driving chip is configured to cause at least one of the first zone, the second zone, and the first foldable zone to be in a display state according to the bending signal; and
the touch chip is configured to cause at least one of the first zone, the second zone, and the first foldable zone to be an effective touch zone according to the bending signal.

5. The foldable screen of claim 4, wherein the detecting module comprises a detecting unit and an identification unit;
wherein the detecting unit is configured to detect a folding angle of the foldable screen; and
the identification unit is configured to identify a zone of the foldable screen corresponding to a user.

6. The foldable screen of claim 5, wherein:
the foldable screen is in an unfolded state when the folding angle is 0 degree, and the driving chip causes the first zone, the second zone, and the first foldable zone to be in a display state; and
the foldable screen is in a folded state when the folding angle is 180 degrees;
the driving chip causes the first zone, the second zone, and the first foldable zone to be in a non-display state when the foldable screen is in an inward folded state;
the driving chip causes the first zone facing the user to be in a display state, the second zone and the first foldable zone facing away from the user in a non-display state when the foldable screen is in an outward folded state; or
the driving chip causes the second zone facing the user to be in a display state, and the first zone and the first foldable zone facing away from the user in a non-display state when the foldable screen is in an outward folded state.

7. The foldable screen of claim 5, wherein:
the touch chip causes the first zone and the first foldable zone facing away from the user to be invalid touch zones, and the second zone facing the user to be an effective touch zone when the foldable screen is in an outward folded state; or
the touch chip causes the second zone and the first foldable zone facing away from the user to be invalid touch zones, and the first zone facing the user to be an effective touch zone when the foldable screen is in an outward folded state.

8. The foldable screen of claim 5, wherein:
the touch chip causes the first electrode in the first zone and the first electrode and the second electrode in the first foldable zone facing away from the user to be in an inactive state, and the second electrode in the second zone facing the user to be in an active state when the foldable screen is in an outward folded state; or
the touch chip causes the second electrode in the second zone and the first electrode and the second electrode of the first foldable zone facing away from the user to be in an inactive state, and the first electrode in the first zone facing the user to be in an active state when the foldable screen is in an outward folded state.

9. The foldable screen of claim 1, wherein the foldable screen further comprises a third zone and a second foldable zone; and
the second foldable zone is between the third zone and the second zone.

10. The foldable screen of claim 9, wherein a sum of surface areas of the first zone and the third zone is equal to a surface area of the second zone; or
the first zone, the second zone, and the third zone have equal surface areas.

11. A method of controlling a foldable screen, the foldable screen comprising a first zone, a second zone, and a first foldable zone between the first zone and the second zone, wherein the method of controlling the foldable screen comprises:
detecting a bending state of the foldable screen and outputting a bending signal; and
causing at least one of the first zone, the second zone, and the first foldable zone to be in a display state according to the bending signal.

12. The method of claim 11, wherein detecting the bending state of the foldable screen and outputting the bending signal comprises the following steps:
detecting a folding angle of the foldable screen; and
determining a zone of the foldable screen facing the user according to the folding angle of the foldable screen and outputting the corresponding bending signal.

13. The method of claim 11, wherein:
the foldable screen further comprises a driving chip;
the foldable screen is in an unfolded state when the folding angle is 0 degree, and the driving chip causes the first zone, the second zone, and the first foldable zone to be in a display state; and
the foldable screen is in a folded state when the folding angle is 180 degrees;
the driving chip causes the first zone, the second zone, and the first foldable zone to be in a non-display state when the foldable screen is in an inward folded state;
the driving chip causes the first zone facing the user to be in a display state, and the second zone and the first foldable zone facing away from the user in a non-display state when the foldable screen is in an outward folded state; or
the driving chip causes the second zone facing the user to be in a display state, and the first zone and the first foldable zone facing away from the user in a non-display state when the foldable screen is in an outward folded state.

14. The method of claim 11, wherein:
the foldable screen further comprises a touch chip; and
the touch chip causes the first zone and the first foldable zone facing away from the user to be in invalid touch zones, and the second zone facing the user to be in an effective touch zone when the foldable screen is in an outward folded state; or
the touch chip causes the second zone and the first foldable zone facing away from the user to be invalid touch zones, and the first zone facing the user to be an effective touch zone when the foldable screen is in an outward folded state.

15. The control method of claim 11, wherein:
a first touch electrode is disposed in the first zone;
a second touch electrode is disposed in the second zone; and
the first foldable zone is provided with:
a first electrode electrically connected to the first touch electrode;
a second electrode electrically connected to the second touch electrode; and
a barrier electrode between the first electrode and the second electrode.

16. The control method of claim 15, wherein the barrier electrode extends from a first side of the foldable screen to a second side opposite the first side.

17. The control method of claim 15, wherein the barrier electrode has a width of less than 1 cm.

18. The control method of claim 15, wherein:
the touch chip causes the first electrode in the first zone and the first electrode and the second electrode in the first foldable zone facing away from the user to be in an inactive state, and the second electrode in the second zone facing the user to be in an active state when the foldable screen is in an outward folded state; or
the touch chip causes the second electrode in the second zone and the first electrode and the second electrode of the first foldable zone facing away from the user to be in an inactive state, and the first electrode in the first zone facing the user to be in an active state when the foldable screen is in an outward folded state.

19. The control method of claim 11, wherein the foldable screen further comprises a third zone and a second foldable zone; and
the second foldable zone is between the third zone and the second zone.

20. The control method of claim 19, wherein a sum of surface areas of the first zone and the third zone is equal to a surface area of the second zone; or
the first zone, the second zone, and the third zone have equal surface areas.
